(19) United States
(12) Patent Application Publication
(10) Pub. No.: US 2014/0379560 A1
(43) Pub. Date: Dec. 25, 2014

(54) Automatic interest conversion program

(71) Applicant: Vinings Capital Management, LLC, Smyrna, GA (US)

(72) Inventor: Tim Harcourt, Smyrna, GA (US)

(21) Appl. No.: 13/941,611

(22) Filed: Jul. 15, 2013

Related U.S. Application Data
(60) Provisional application No. 61/837,996, filed on Jun. 21, 2013.

(51) Int. Cl. G06Q 20/24; G06Q 20/10

(52) U.S. Cl. CPC G06Q 20/24; G06Q 20/10
USPC 705/39

(57) ABSTRACT

A computer implemented method is provided for automatically converting bank account interest transactions into additional principal payments on mortgage accounts. The method further allows the customer to overlay an increase factor, on the interest amount, to increase the amount of the additional mortgage principal payment. The method further includes automatically debiting the product of the interest transaction and the increase factor (if applicable) from each enrolled interest bearing account, summing each amount and crediting the total to a customer's mortgage account in the form of an additional principal payment.

### CROSS-REFERENCE TO RELATED APPLICATION

This is the non provisional application specification for the previously submitted provisionary application No. 61/837,996, filed on Jun. 21, 2013.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### FIELD OF INVENTION

The present invention refers to the field of consumer banking.

### BACKGROUND OF THE DISCLOSURE

Home equity has been one of the largest contributors to individual wealth creation in this country's history. This equity has traditionally been created either through the increase in a homes' value relative to the outstanding mortgage or through the pre-payment of additional monthly principal by home owners. Over the last half decade, home values have experienced multi-generational decreases leaving a slowly mounting debt burden on the average home owner. Additionally, elevated inflation levels are causing individual home owners to spend discretionary dollars on things other than their mortgage. Families who could once afford to make additional monthly principal payments on their home mortgage can no longer do so as those dollars have shifted to purchase other staples.

These days, most mortgage borrowers have a standing, recurring money transfer to pay their monthly mortgages directly from their bank accounts. This usually requires no manual action by the borrower. Depending on the loan type, if the borrower chooses to make an additional principal payment for any given month, the mechanism to do so, in most cases, is manual. For those borrowers who can afford to make this incremental principal payment each month, not all of them remember to do so and thus, experience an opportunity cost. The current transfer functionality does not adequately support the ability for borrowers to make recurring, automated additional principal repayments of varying amounts.

From the banks' perspective, customer loyalty for personal banking and financing has never been lower. The internet allows consumers to instantaneously compare interest rates and fees across multiple institutions while websites can easily facilitate the quick transfer of deposits between banks. On the lending front, for those customers who can afford the closing costs associated a mortgage refinancing arrangement, the internet allows them to compare multiple mortgage financers at once. Armed with the ability to quickly compare pricing across multiple lenders, borrowers tend to partner with those lenders that can offer the most favorable refinancing terms. The rapid adoption of these technologies by the consumer base is decreasing customer loyalty at commercial banks. The average consumer is no longer bound to the traditional concept of a brick-and-mortar local bank.

A solution is needed to enhance the mortgage customers' ability to service additional mortgage principal, in an automated fashion, while improving customer loyalty and retention for the banks.

### SUMMARY OF THE INVENTION

One embodiment of the present invention is a computer implemented method, created and owned by a bank or financial institution, that automatically converts the monthly interest transaction on a customer checking, savings, money market or other interest bearing account(s) into an additional monthly principal pay down on that customers mortgage account (or multiple mortgage accounts). The method further allows the customer to overlay an increase factor, on the interest amount, to increase the amount of the additional mortgage principal payment, The method further includes automatically debiting the product of the interest transaction and the increase factor (if applicable) from each enrolled interest bearing account, summing each amount and crediting the total to a customer's mortgage account in the form of an additional principal payment.

The advantages of the present invention to consumers may include:
An increase in home equity driven by the incremental, additional mortgage principal repayments each month.
Significant long term interest savings on mortgage debt.
An improved credit score achieved by paying down incremental home debt each period.
A decrease in personal income taxes as interest income is now converted to debt servicing.
Peace of mind and increased confidence knowing that they now own more of their home.

The advantages of the present invention to consumer bankers may include:
An increase in bank revenue as individual account holders are now incented to hold as much money in interest bearing accounts as possible. The consumer will now want to generate the highest monthly interest possible and thus, ad hoc purchasing decisions will likely be made by credit card versus debit card. The retention of these balances overnight will generate additional revenue for the bank.
Decreased customer attrition rates on mortgage and bank account holders as the average consumer will now be less inclined to disrupt this automatic payment setup. The bank could also choose to offer additional rewards to the consumer for holding both the bank account and mortgage account with that bank.

### BRIEF DESCRIPTION OF THE DRAWINGS

FIG. 1 is an illustration of the calculation performed in accordance with enrollment in the automatic interest conversion program.

FIG. 2 is a flow diagram of the functionality performed in accordance with the customer enrollment process in the automatic interest conversion program.

FIG. 3 is a flow diagram of the post-enrollment functionality performed to process the transaction created by the automatic interest conversion program.

### DETAILED DESCRIPTION

Referring now in more detail to the drawings

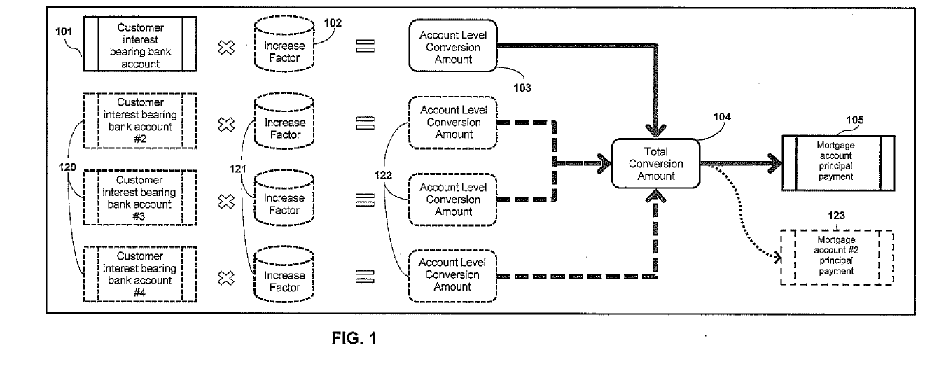

FIG. 1 is an illustration of the calculation performed in accordance with enrollment in the automatic interest conversion program where dashed lines represent optional items to the customer. The automatic interest conversion program allows the customer to enroll one or multiple interest bearing accounts in the program, and accordingly, the below description will walk through both scenarios. If a customer elects to have a single interest bearing account participate in the program, the calculation follows these steps:

101: The bank posts an interest transaction to the customer interest bearing bank account. Examples of eligible interest bearing accounts are, but not limited to, checking, savings and money market bank accounts.

102: If applicable, the interest amount 101 is multiplied by an increase factor 102 selected by the customer during the automatic interest conversion program enrollment process. The possible application of an increase factor exists based on the fluctuating nature of interest rates. For example, we are currently in a very low interest rate environment and that could be the case for the next decade. Based on this low rate environment, interest bearing accounts may only be earning a few cents in interest each month. Paying down an extra penny or two of mortgage principal each month may achieve some slight improvement in a customer's credit score, but it will make little difference to a customers' outstanding mortgage principal. Hence, the program gives the customer the ability to increase this repayment amount, by electing an increase factor to apply to the interest transaction, to make the principal pay down more meaningful. The program would allow each enrolled customer to periodically alter the increase factor for each participating bank account.

103: The product of the interest amount 101 and the increase factor 102, if applicable, is the account level conversion amount 103. If no increase factor 102 was elected during the enrollment process, then the interest amount 101 will equal the account level conversion amount 103. Assuming there is enough balance in the customer bank account 101 to support a debit transaction in the amount of the account level conversion amount 103, the program will then debit the customer bank account 101 for the account level conversion amount 103.

104: The account level conversion amount is now the total conversion amount 104.

105: The total conversion amount 104 is then applied to the predetermined customer mortgage account 105, or to multiple customer mortgage accounts 123, in the form of an additional principal payment(s). These mortgage accounts shall be identified in the enrollment process. The principal payment transaction shall be handled in the most cost effective manner for the bank hosting the program (e.g. ACH) but could also be transacted via a wire transfer. This payment is an additional payment to the customer's normal monthly mortgage payment.

If the customer elects to have multiple source accounts participate in the program, the calculation follows these steps:

120: The bank posts interest transactions to multiple customer interest bearing accounts.

121: If applicable, each interest amount 120 is multiplied by an increase factor 121 selected by the customer during the automatic interest conversion program enrollment process.

122: The product of each interest amount 120 and each increase factor 121, if applicable, is the account level conversion amount 122 for each account. If no increase factor 121 is elected during the enrollment process, then each interest amount 120 will equal each account level conversion amount 122. Assuming there is enough balance in each customer interest bearing bank account 120 to support a debit transaction in the amount of the each individual account level conversion amount 122, the program will then debit each customer bank account 120 for the account level conversion amount 122.

104: The sum of each account level conversion amount 122 is the total conversion amount 104.

123: The total conversion amount 104 is then applied to the customer mortgage account 105, or to multiple customer mortgage accounts 123, in the form of an additional principal payment(s). These mortgage accounts shall be identified in the enrollment process. The principal payment transaction shall be handled in the most cost effective manner for the bank hosting the program (e.g. ACH) but could also be transacted via a wire transfer. This payment is an additional payment to the customer's normal monthly mortgage payment.

Under this scenario where the customer has elected multiple source accounts to participate in the program, the total conversion is calculated as follows:

Total Conversion Amount=[interest on account#1+(interest on account#1*Increase Factor)]+[interest on account#2+(interest on account#2*Increase Factor)]+[interest on account#3+(interest on account#3*Increase Factor)]+[interest on account#4+(interest on account#4*Increase Factor)]. . . .

For example, if the customer earns $0.38 in monthly interest on their checking account, $2.11 in monthly interest on their savings account and $6.14 in monthly interest on their money market account and they had requested an increase factor of 10 for each account during the enrollment process, the total conversion amount would be calculated as follows:

| | | | | Account | |
|---|---|---|---|---|---|
| | | Increase | | Level | |
| | | Factor | Interest × | Conversion | |
| Account | Interest | (IF) | IF | Amount | |
| Checking | $0.38 | 10 | $3.80 | $4.18 | |
| Savings | $2.11 | 10 | $21.10 | $23.21 | |
| Money | $6.14 | 10 | $61.40 | $67.54 | |
| Market | | | | $94.93 | Total |
| | | | | | Conversion |
| | | | | | Amount |

In this example, the customer would have an additional monthly principal payment on their home mortgage of $94.93.

In one embodiment of the present invention, the customer can set the monthly total conversion amount to a pre-determined, static amount. If this option is taken, the automatic interest conversion program will calculate the individual account level increase factor needed to arrive at the pre-determined customer elected total conversion amount. For example, if the customer wants to have the total conversion amount set at $100 per month, then the program will reverse calculate the account level conversion amounts and increase factors for each participating account. In this example and with three participating accounts, the calculation would look like this:

| | | | | Account | |
|---|---|---|---|---|---|
| | | Increase | | Level | |
| | | Factor | Interest × | Conversion | |
| Account | Interest | (IF) | IF | Amount | |
| Checking | $0.38 | 10.5875 | $4.02 | $4.40 | |
| Savings | $2.11 | 10.5875 | $22.34 | $24.45 | |
| Money | $6.14 | 10.5875 | $65.01 | $71.15 | |
| Market | | | | $100.00 | Total |
| | | | | | Conversion |
| | | | | | Amount |

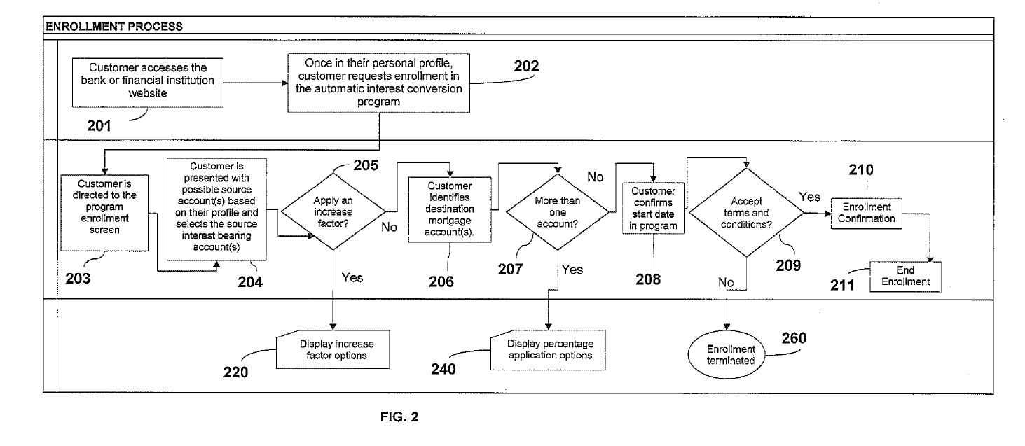

FIG. 2 is a flow diagram of the functionality performed in accordance with the customer enrollment process in the automatic interest conversion program. The functionality of FIG. 2 is implemented by a program within the banks' online banking platform.

201: The customer will access a website hosted and owned by the bank or financial institution.

202: The customer will login to that website, hosted and owned by the bank or financial institution, to access their personal profile. Once the customer has accessed their personal profile, they request enrollment in the automatic interest conversion program.

203: The program enrollment screen is displayed in response to a customer request to enroll in the automatic interest conversion program.

204: The customer is then presented with all eligible source accounts that could be used to participate in the program. Eligible source accounts would be those that generate recurring interest to the customer on at least a monthly basis and are held with that bank or financial institution. Examples of eligible accounts are, but not limited to, checking, savings and money market bank accounts.

205: After selecting the source accounts to participate in the program, the customer is then presented with the option to apply an increase factor to the interest amount from each source account. If the customer chooses to apply an increase factor to the interest amount they would elect the increase factor on a display interface 220 presented to them in this part enrollment in the automatic interest conversion program. The increase factor could be periodically altered by the customer post-enrollment.

206: Once the source accounts and any increase factors associated with those accounts have been determined, the customer is then taken to a screen where they will identify the destination mortgage accounts to which the total conversion amount could be directed. Eligible destination accounts can be those mortgage accounts held with the same financial institution or an external lender assuming the loans are structured to accept an additional monthly mortgage interest payment. For external accounts, the customer would supply all the necessary routing information for payments. In one embodiment of the present invention, the bank hosting this program can offer customer rewards to intent customers to maintain or establish mortgage accounts with that same bank.

207: If the customer wants the total conversion payment to be applied to multiple mortgage accounts, an account percentage application screen 240 will be displayed on the user interface in this part of the automatic interest conversion program. The customer will determine the percentage of the total conversion amount to be applied to each account on this screen. The total must equal 100 percent before the enrollment process continues.

208: Once the destination mortgage account(s) have been determined, the customer will confirm the start date for their inclusion in the program by selecting a date presented to them in this part of the enrollment in the automatic interest conversion program.

209: The customer is taken to a page that summarizes the customer's selections and is presented with the program terms and conditions. If the customer does not accept these terns and conditions, the enrollment is terminated 260.

210: Customer acceptance of the terms and conditions results in a successful enrollment in the automatic interest conversion program and a confirmation of this enrollment is presented to the customer.

211: Customer enrollment in the automatic interest conversion program is complete.

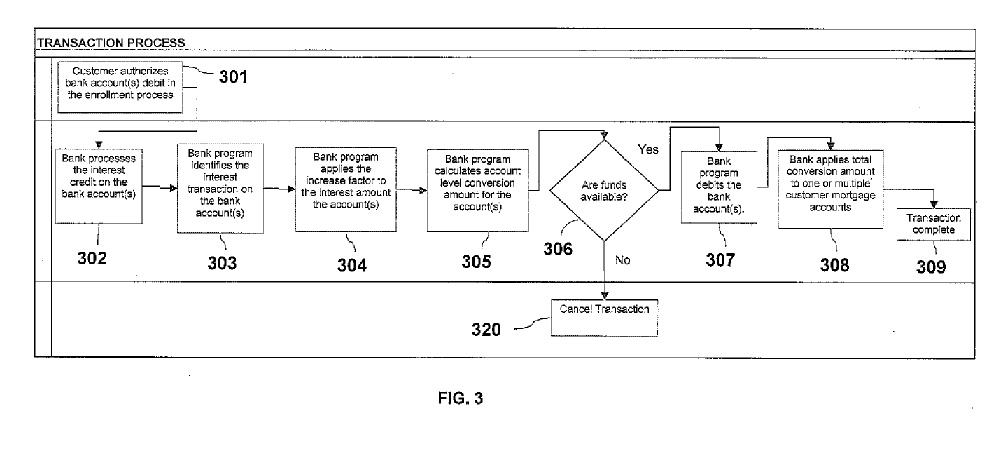

FIG. 3 is a flow diagram of the post-enrollment functionality performed to process the transaction created by the automatic interest conversion program.

301: The customer authorizes future debits to their account(s) as part of the enrollment process from FIG. 2,

302: The bank will process the normal monthly interest credit to the bank account(s).

303: The program will identify the interest transaction on each account.

304: If applicable, the program will apply any pre-designated increase factor to the identified interest amount for the account(s).

305: The program calculates the account level conversion amount for the account(s) which is the product of the interest amount and increase factor.

306: Once the calculation from 305 is complete, the program determines if the bank account(s) has enough balance to process a debit to the account(s). If not, no debit transaction will be processed from the account(s) and the transaction is cancelled 320.

307: If the customer has only one account participating in the program then the account level conversion amount equals the total conversion amount. The total conversion amount is debited from the bank account. If the customer has multiple accounts subscribing to the program, the program will debit each account for each account level conversion amount. The sum of each account level conversion amount shall equal the total conversion amount.

308: The bank program applies the total conversion amount to the customers mortgage account in the form of an additional monthly principal payment. If the customer chooses to apply the total conversion amount to more than one mortgage, the total conversion amount is subdivided and applied to each pre-selected mortgage account in the customer designated percentages determined in the enrollment process 240 from FIG. 2.

309: The transaction is now complete.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

The embodiments of the invention in which an exclusive property or privilege is claimed are defined as follows:

1. A method for creating a mortgage payment through the automatic conversion of an interest transaction at a bank or financial institution.

2. The method of claim 1, where the mortgage payment is independent of the customer's normal monthly mortgage payment process and where enrollment in the program results in an additional monthly mortgage payment.

3. The method of claim 2, where the additional monthly mortgage payment is applied to mortgage principal only.

4. The method of claim 1 comprising of the ability for the customer to enroll more than one interest bearing account in the program.

5. The method of claim 1, comprising of the ability of the customer to apply an increase factor to the interest amount generated on each enrolled account.

6. The method of claim 1 wherein calculating the additional mortgage payment comes from summing the product of the interest amount and the increase factor for each enrolled account.

7. The method of claim 1 wherein each portion of the additional mortgage payment is automatically debited from each enrolled customer account and automatically credited to one, or more, customer mortgage accounts.

8. The method of claim 1 where the customer can choose, from time-to-time, to periodically alter the increase factor for each participating bank account.
